(19) United States
(12) Patent Application Publication
(10) Pub. No.: US 2006/0103245 A1
(43) Pub. Date: May 18, 2006

(54) Engine cooling motor-module ventilation configuration

(75) Inventors: Attila Simofi-llyes, London (CA); Shan Mugan, London (CA); Andrew Lakerdas, London (CA); Paul Stephen McLennan, London (CA)

Correspondence Address: Elsa Keller, Legal Assistant;Intellectual Property Department, SIEMENS CORPORATION, 170 Wood Avenue South, Iselin, NJ, 08830, US

(73) Assignee: Siemens VDO Automotive Inc.

(21) Appl. No.: 11/042,273

(22) Filed: Jan. 24, 2005

Related U.S. Application Data
(60) Provisional application No. 60/627,677, filed on Nov. 12, 2004.

(51) Int. Cl. H02K 9/00; H02K 3/24; H02K 5/00

(52) U.S. Cl. 310/58; 310/64; 310/89; 310/91

(57) ABSTRACT

A permanent magnet D.C. electric motor 100 includes a motor housing 118 having first and second ends and a generally cylindrical periphery between the ends. The first end 120 is substantially closed and has an end of a shaft 124 extending there from. The first end includes vent holes 16 therein. The second end 122 is substantially open and defines a plurality of ventilation holes 126 in the cylindrical periphery. An end cap 130 closes the second end and covers another end of the shaft. The end cap has a base 132 and a flange 134 extending transversely with respect to the base. The flange is disposed over a portion of the cylindrical periphery of the housing so as to define a gap G there-between such that air may pass through the gap and through the ventilation holes and vent holes to cool the motor, with the end cap inhibiting foreign material from entering the ventilation holes.

This applicant is based on U.S. Provisional Application No. 60/627,677, filed on Nov. 12, 2004 and claims the benefit thereof for priority purposes.

### FIELD OF THE INVENTION

This invention relates to Permanent Magnet Direct Current Motors (PMDCM) for automotive applications such as engine cooling.

### BACKGROUND OF THE INVENTION

FIG. 1 shows a conventional ventilation configuration of an engine cooling permanent magnet DC brush motor 10. The airflow path through the motor is shown by the curved lines A. The conventional motor ventilation configuration is very effective; however, the cooling airflow path through the motor 10 requires vent holes 12 in an end cap 14 of the motor 10. FIG. 2 shows the end cap 14 having vent holes 12 therein, and FIG. 3 shows the fan side (which is opposite to end cap side) of the motor 10 with vent holes 16 in the stator assembly. FIG. 4 shows an inside face of engine cooling fan hub 18 where features, such as cooling fins 20, are molded to create pressure differential through the motor 10. A reduced static pressure is created at stator end 26 of the motor 10 by the rotating fins 20. Thus, ambient air is drawn into the motor through the vent holes 12 and hot air is drawn out of the motor through holes 16 in the stator.

The conventional vented motor configuration does not fulfill the salt-spray, dust and muddy-water spray test requirements stipulated by some auto manufacturers since contamination can enter into the motor 10 through the open vent holes 12 in the end cap. With reference to FIG. 1, an excessive amount of contamination entering the motor can eventually form a very abrasive and poor electrically conductive layer on the top of the bars of the commutator 22. In addition, the solidified contamination can seize the brushes in the brush tubes 24. Consequently, the applied voltage is not conveyed to the armature winding 28 and the motor can stop operating.

Thus, in order to meet the customers' durability specifications, currently a splash shield is mounted to the shroud to shield the ventilation holes in the end cap of the motor. FIG. 5 shows a dual cooling module assembly 30 (two motors and two fans on one shroud 32) where a splash shield 34 is mounted behind each motor 10. This solution requires additional components and process steps. Therefore, the cost of the module 30 increases. More importantly, this solution is not “robust” because contamination still can enter into the motor 10 since there is a gap between the motor 10 and the splash shield 34. Consequently, there is a need for a more robust and economical solution for providing motor venting and yet reduce the chance of motor contamination.

The splash shield also can be integrated into the plastic module and this configuration is available on the market. This is accomplished by closing up the opening on the plastic module at the motor end cap side. However, this type of configuration limits the motor mounting to “front mount” to the plastic shroud. Furthermore, a larger axial space is required for such module/motor and fan assembly.

There are also a variety of different closed motors and closed end cap motor configurations available on the market, however, in these cases, the motor power level is limited to low or medium power depending on the durability requirements specified by the auto manufacturers.

Therefore, considering all of the above, there is a need for a new, improved motor ventilation configuration that does not limit the motor functionality under certain environmental conditions.

### SUMMARY OF THE INVENTION

An object of the invention is to fulfill the need referred to above. In accordance with the principles of the present invention, this objective is achieved by providing a permanent magnet D.C. electric motor 100 including a motor housing having first and second ends and a generally cylindrical periphery between the ends. The first end is substantially closed and has an end of a shaft extending there from. The first end includes vent holes therein. The second end is substantially open and defines a plurality of ventilation holes in the cylindrical periphery. An end cap closes the second end and covers another end of the shaft. The end cap has a base and a flange extending transversely with respect to the base. The flange is disposed over a portion of the cylindrical periphery of the housing so as to define a gap G there-between such that air may pass through the gap and through the ventilation holes and vent holes to cool the motor, with the end cap inhibiting foreign material from entering the ventilation holes.

In accordance with another aspect of the invention, an engine cooling module includes a shroud structure and a permanent magnet D.C. electric motor mounted to the shroud structure. The motor includes a motor housing having first and second ends and a generally cylindrical periphery between the ends. The first end is substantially closed and has an end of a shaft extending there from. The first end includes vent holes therein. The second end is substantially open and defines a plurality of ventilation holes in the cylindrical periphery. An end cap closes the second end and covers another end of the shaft. The end cap has a base and a flange extending transversely with respect to the base. The flange is disposed over a portion of the cylindrical periphery of the housing so as to define a gap G there-between such that air may pass through the gap and through the ventilation holes and vent holes to cool the motor, with the end cap inhibiting foreign material from entering the ventilation holes. The module includes a fan coupled to the operative end of the shaft.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a sectional view of a conventional PMDCM showing ventilation thereof.

FIG. 2 is a perspective view of a conventional PMDCM showing an end cap with venting.

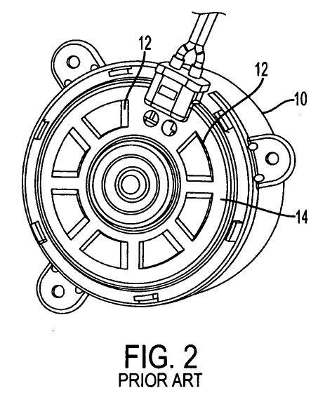

FIG. 3 is a view of the motor of FIG. 2, showing the stator side of a conventional PMDCM with vent holes therein.

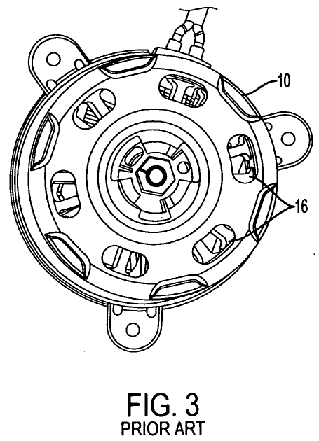

FIG. 4 is a view of an inside face of a conventional engine cooling fan hub showing cooling fins thereof.

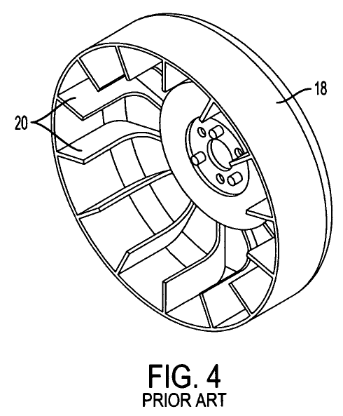

FIG. 5 is a view of a dual engine cooling module showing splash shield mounted thereto.

FIG. 6 is a sectional view of an engine cooling module provided in accordance with principles of the invention showing airflow there-through.

FIG. 7 is a view of dual engine cooling fan module in accordance with the invention.

FIG. 8 is a perspective view in section of the electric motor of the engine cooling module of FIG. 6.

### DETAILED DESCRIPTION OF THE EXEMPLARY EMBODIMENT

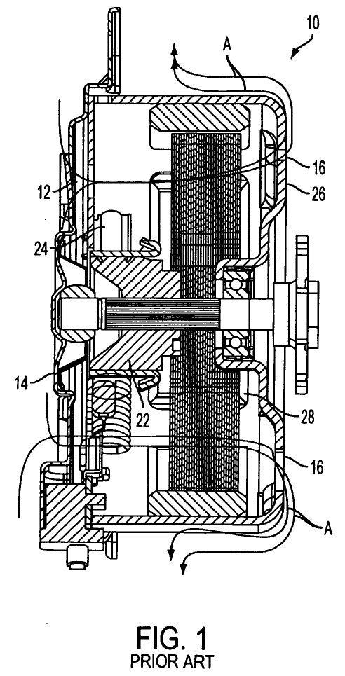

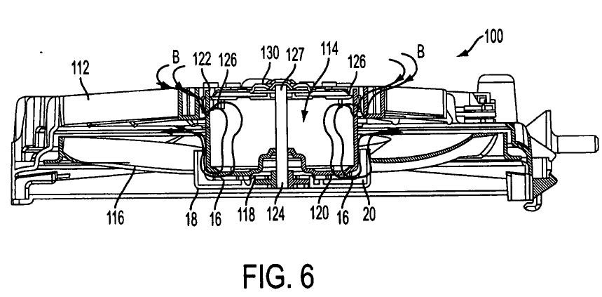

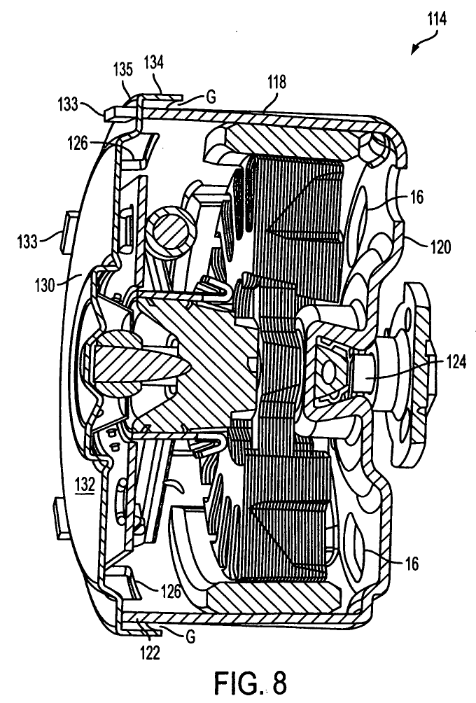

An engine cooling module, in accordance with the principles of the present invention, is shown in section and is generally indicated in 100 in FIG. 6. The module 100 includes a shroud 112, a motor, generally indicated at 114, coupled to the shroud, and a fan 116 coupled to a shaft 124 for rotation therewith. As best shown in FIG. 8, the motor 114 has a housing 118 having a first end 120 and a second end 122 and a generally cylindrical periphery between the ends. As shown in FIG. 6, the substantially closed first end, considered the stator end, has a shaft 124 mounted for rotation extending there from. The stator end 120 can be considered to be identical to that of FIG. 1, having vent holes 16 therein for venting the motor. In addition, the hub 18 of the fan 116 includes the fins 20 so as to create a low pressure region for drawing ambient air into the motor 114 as will be explained more fully below. The conventional internal parts of the permanent magnet DC motor 114 are not shown in FIG. 6 for clarity of illustration, but can be seen in FIG. 8.

With reference to FIGS. 6 and 8, instead of providing vent holes in the end cap as in FIG. 1, the second end 122 of the housing 118 has a plurality of ventilation holes 126 in the cylindrical periphery thereof. Thus the ventilation holes 126 can be considered to be steps or cut-outs in the periphery of the housing 118, extending from end 122 in the direction of end 120 (FIG. 8). The second end 122 is substantially open and is closed by the end cap 130. Thus, the end cap 130 is a closed end cap, disposed over the second end 122 of the motor housing 118 and thus over the ventilation holes 126 and shaft end 127. The end cap 130 has a base 132 and an annular flange 134 extending transversely with respect to the base 132. The flange 134 is disposed over a portion of the cylindrical periphery of the housing 118 so as to define a gap G there-between (FIG. 8). Thus, as shown in FIG. 6, venting ambient air represented by arrows and lines B may pass under the flange 134, through the gap G, through the ventilation holes 126, into the interior of the housing 118, and out of the housing 118 via the holes 16 in the stator end 120. Thus, the closed end cap 130 inhibits foreign material from entering the ventilation holes 126. The end cap 130 provides effective splash shielding and it is difficult for contamination to enter into the motor 114. In addition, the hub 18 provides a shield so that it is difficult for foreign material to enter vent holes 16.

In order to secure the end cap 130 to the housing 118, as shown in FIG. 8, the housing 118 has tabs 133 extending from end 122 thereof that are received in opening 135 in the base 132 of the end cap 130. The tabs 133 are staked or deformed to secure the end cap 130 to the housing 118.

There are times, although few, when the front of the vehicle (or the entire vehicle) is submersed in water for a short period of time. Thus, water can enter into the electric motor 114 of the engine cooling module 100. However, the water will drain out from the motor 114 through the ventilation holes 126 as soon as the vehicle is removed from the water.

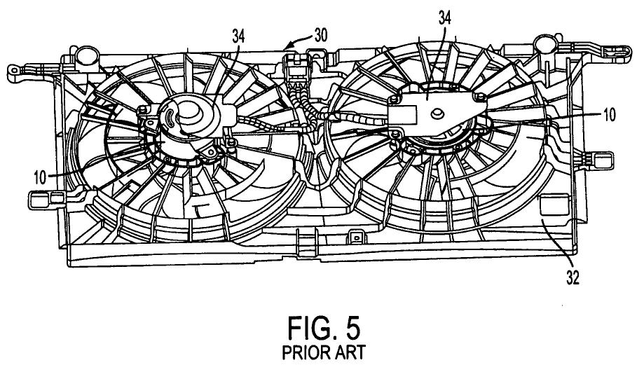

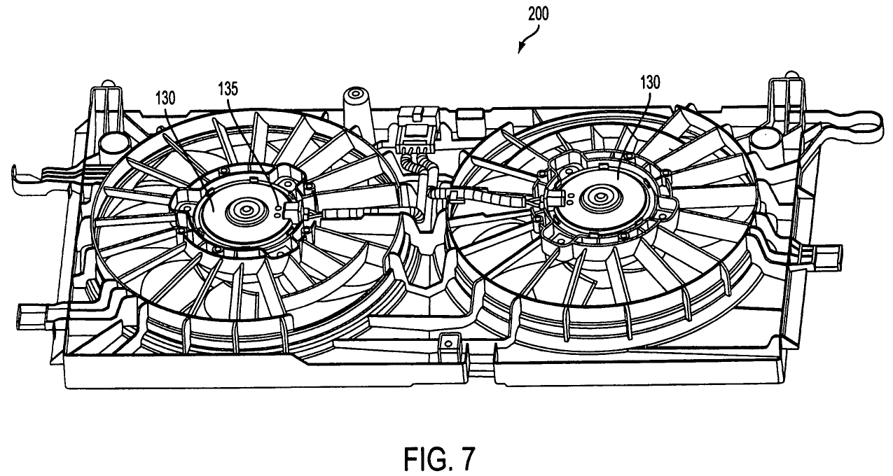

FIG. 7 shows a dual engine cooling module 200 with the closed end cap 130 and ventilation holes 126 (not shown) in accordance with the in invention. This module 200 is same as the one shown in FIG. 5, except it has improved venting, (e.g., no splash shield and new end cap configuration and peripheral ventilation holes 126 in the motor housing). It is noted that holes 135 in the end cap 130 are for performance testing and are covered after the module 200 is tested successfully.

It can be appreciated that the direction of the ventilating air may be reversed or changed with respect to arrows A by, for example, 1) providing a different fan hub 18 configuration (such as: the orientation of the fins in the fan hub and/or opening holes on the front face of the fan hub) 2) the application/mounting type of fan module onto the engine cooling radiator in the vehicle; (the end cap of the motor is facing upstream or downstream to the ram air and airflow from the fan).

Features:

1. An engine cooling module with new ventilation strategy shown in FIG. 6 and eliminating the use of additional splash shield component.
2. Closed end cap motor ventilated through ventilation holes in the motor housing (peripheral holes 126 and front holes 16).
3. The holes 126 in the motor housing are for ventilation and also for drainage.
4. The ventilation holes 126 are shielded by a flange on the end cap.

Thus, it can be appreciated that the new module configuration provides a more simplistic and more economical solution for an optimized engine cooling module.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A permanent magnet D.C. electric motor comprising:
a motor housing having first and second ends and a generally cylindrical periphery between the ends, the first end being substantially closed and having an end of a shaft extending there from, the first end including vent holes therein, the second end being substantially open and defining a plurality of ventilation holes in the cylindrical periphery, and
an end cap closing the second end and covering another end of the shaft, the end cap having a base and a flange extending transversely with respect to the base, the flange being disposed over a portion of the cylindrical periphery of the housing so as to define a gap there-between such that air may pass through the gap and through the ventilation holes and vent holes to cool the motor, with the end cap inhibiting foreign material from entering the ventilation holes,
wherein the ventilation holes are defined by cut-outs in the periphery of the housing, the cut-buts being open at the second end and extending in a direction towards the first end of the housing, each cut-out being disposed on a circumference of the second end.

2. (canceled)

3. The motor of claim 1, wherein the second end of the housing includes tabs extending there from and away from the first end, the base of the end cap having openings therein, with the tabs being disposed through the openings, the tabs being constructed and arranged to be deformed to secure the end cap to the housing.

4. A permanent magnet D.C. electric motor comprising:
a motor housing having first and second ends, the first end being substantially closed and having an end of a shaft extending there from, the first end including vent holes therein, the second end being substantially open and defining a plurality of ventilation holes in a periphery of the housing, and
an end cap closing the second end and covering another end of the shaft, the end cap having means for covering a portion of the periphery of the housing so as to define a gap there-between such that air may pass through the gap and through the ventilation holes and vent holes to cool the motor, with the end cap inhibiting foreign material from entering the ventilation holes,
wherein the ventilation holes are defined by cut-outs in the periphery of the housing, the cut-outs being open at the second end and extending in a direction towards the first end of the housing, each cut-out being disposed on a circumference of the second end.

5. (canceled)

6. The motor of claim 4, wherein the second end of the housing includes tabs extending there from and away from the first end, the base of the end cap having openings therein, with the tabs being disposed through the openings, the tabs being constructed and arranged to be deformed to secure the end cap to the housing.

7. The motor of claim 4, wherein the periphery of the housing is generally cylindrical.

8. The motor of claim 7, wherein the means for covering is an annular flange.

9. An engine cooling module comprising:
a shroud structure,
a permanent magnet D.C. electric motor mounted to the shroud structure, the motor comprising:
a motor housing having first and second ends and a generally cylindrical periphery between the ends, the first end being substantially closed and having an operative end of a shaft extending there from, the first end including vent holes therein, the second end being substantially open and defining a plurality of ventilation holes in the cylindrical periphery, and
an end cap closing the second end and covering another end of the shaft, the end cap having a base and a flange extending transversely with respect to the base, the flange being disposed over a portion of the cylindrical periphery of the housing so as to define a gap there-between such that air may pass through the gap and through the ventilation holes and vent holes to cool the motor, with the end cap inhibiting foreign material from entering the ventilation holes, and
a fan coupled to the operative end of the shaft,
wherein the ventilation holes are defined by cut-outs in the periphery of the housing, the cut-outs being open at the second end and extending in a direction towards the first end of the housing each cut-out being disposed on a circumference of the second end.

10. (canceled)

11. The module of claim 9, wherein the second end of the housing includes tabs extending there from and away from the first end, the base of the end cap having openings therein, with the tabs being disposed through the openings, the tabs being constructed and arranged to be deformed to secure the end cap to the housing.

12. The module of claim 9, wherein the fan includes a hub, the hub having fins constructed and arranged to create a pressure at the first end of the housing upon rotation of the fan to permit air to be drawn into the housing by entering through the gap and through the ventilation holes and exit the housing through the vent holes.

13. An engine cooling module comprising:
a shroud structure,
two permanent magnet D.C. electric motors mounted to the shroud structure, each motor comprising:
a motor housing having first and second ends and a generally cylindrical periphery between the ends, the first end being substantially closed and having an operative end of a shaft extending there from, the first end including vent holes therein, the second end being substantially open and defining a plurality of ventilation holes in the cylindrical periphery, and
an end cap closing the second end and covering another end of the shaft, the end cap having a base and a flange extending transversely with respect to the base, the flange being disposed over a portion of the cylindrical periphery of the housing so as to define a gap there-between such that air may pass through the gap and through the ventilation holes and vent holes to cool the motor, with the end cap inhibiting foreign material from entering the ventilation holes, and
a fan coupled to the operative end of the shaft of an associated motor,
wherein the ventilation holes are defined by cut-outs in the periphery of the housing, the cut-outs being open at the second end and extending in a direction towards the first end of the housing, each cut-out being disposed on a circumference of the second end.

14. (canceled)

15. The module of claim 13, wherein the second end of the housing includes tabs extending there from and away from the first end, the base of the end cap having openings therein, with the tabs being disposed through the openings, the tabs being constructed and arranged to be deformed to secure the end cap to the housing.

16. The module of claim 13, wherein each fan includes a hub, the hub having fins constructed and arranged to create a pressure at the first end of an associated housing upon rotation of the fan to permit air to be drawn into the housing by entering through the gap and through the ventilation holes and to exit the housing through the vent holes.
